(19) United States
(12) Patent Application Publication
(10) Pub. No.: US 2023/0181410 A1
(43) Pub. Date: Jun. 15, 2023

(54) LIFT TRANSFER APPARATUS

(71) Applicant: Innomotive L.L.C, Bloomfield, MI (US)

(72) Inventor: Tianfu Li, Bloomfield, MI (US)

(21) Appl. No.: 18/076,622

(22) Filed: Dec. 7, 2022

(30) Foreign Application Priority Data
Dec. 9, 2021 (CN) 202123120564.3

(51) Int. Cl. A61H 3/04; A61G 7/10

(52) U.S. Cl. CPC A61H 3/04; A61G 7/1019; A61G 7/1048; A61G 7/1051; A61G 7/1059; A61H 2201/1635; A61H 2201/1215; A61H 2201/1652; A61H 2201/164; A61H 2201/1253; A61H 2201/503; A61H 2003/043; A61H 2201/1633

(57) ABSTRACT

A lift transfer device for disabled people includes a wheeled chassis having a column with a bottom end attached to the chassis and a top end including an arm rest. A winch is provided that is supported by the chassis and/or the column. The winch includes a tow rope having a distal end and a hook disposed at the distal end of the tow rope. The tow rope runs through one or more guide rings disposed on the column and the arm rest. A harness is provided that is worn by a user of the lift transfer device. The hook on the tow rope may be connected to a pulling loop on the harness, the winch facilitates a lifting of the user as the tow rope is retracted by the winch and a lowering of the user as the tow rope is paidout by the winch.

### CROSS-REFERENCE TO RELATED APPLICATIONS

This application claims priority to Chinese Patent Application No. 202123120564.3, filed on Dec. 9, 2021, the entire disclosure of which is hereby incorporated herein by reference.

### FIELD

The present invention relates to an assistive device, in particular a mobility aid for persons with disabilities.

### BACKGROUND

The mobility aids are used to help improve the mobility of patients, such as the injured and/or the disabled. Such mobility aids include manual or electric wheelchairs, which greatly increases the mobility of the patient, but they also have limitations, such as the patient has to use it in sitting position, greatly limiting functionality. In order to allow patients to stand, standing wheelchairs or standing tables have also emerged in the market, but these kinds of wheelchairs and standing tables are complex in structure, cumbersome to use, occupy a lot of space, and not easy to move around while in standing position. For many patients, moving from bed or chair to wheelchair is a great challenge. For this reason, many different kinds of suspension transfer lifts are available on the market, which can help people with injuries and disabilities move from bed or chair to wheelchair or to toilet. But it does not help them to move around in the distance and always needs other people to assist and operate.

### SUMMARY

The object of the present invention is to provide an assistive device for disabled person mobility, which not only helps the patient to transfer from bed to toilet or chair, and can also support the patient to maintain standing, and can help the patient to move around while in standing position. It can also assist the patient with walking while in a fully protected and supported standing position. Furthermore, All these can be managed by the patient themself, which greatly improves the patient's mobility, function and social activity.

To achieve the above goals, the present invention adopts the following technical solutions:

A mobility aid for disabled, including a chassis, at bottom of the front and rear end of chassis has front and rear wheels respectively, a pole extending upwards in the middle front of the chassis, a board with two cushions corresponding to the human shin mounted on the bottom portion of the pole, a winch mounted at the top of the pole, and a safety hook at the end of the tow rope of the winch that connects to the wearable harness.

In one embodiment, the winch is a manual winch, mounted at the top of the column.

In one embodiment, the front and rear wheels are caster wheels.

In one embodiment, the winch is an electric winch, mounted at the top of the pole or at the back of the shin board or on the chassis; a battery is mounted on chassis or at back of the shin board, and the battery is connected with electric winch.

In one embodiment, the top of the pole is provided with a rectangular ring-like handrail. At the top or on the two sides of the handrail are provided with guide rings. The towing rope is separated into two or three ropes, each passing through the corresponding guide ring.

In one embodiment, the top of the pole is provided with a “c” shaped handrail and open toward to back, and at the bottom of both handrails are provided with guide rings. The towing rope is separated into two ropes, each passing through the corresponding guide ring. At this time, the knee board with cushion is optional due to tow rope reach patient side and pulling upward.

In one embodiment, the front wheels are connected to the driving motors, which are connected to the battery.

In one embodiment, the drive motors and winch connect to the control system. The control system is a wire control and a remote-control duo device.

In one embodiment, the pole is surrounded by a sleeve tube. The sleeve tube can pivot around the pole, and there is a tube horizontally connected to the side of the sleeve tube. At the end of the horizontal tube is mounted a seat. The seat can be freely rotated around the pole and also can be locked in place.

In one embodiment, the pole comprises a first vertical tube and a second vertical tube, the two tubes mounted together like telescope. between the two tubes are several corresponding positioning holes, positioning pins go through the position holes connecting the two tubes in an adjustable manner.

In one embodiment, the chassis has a supporting foot board that can be removed, leaving an opening on bottom to allow patient walking.

In one embodiment, the foot board can be flipped up on each side like a double door, allowing the patient to stand on the chassis or stand on the floor. There are caster wheels mounted on the bottom of the free end of each board. There are plates mounted on the chassis frame to support the board.

In one embodiment, the foot board can be flipped up allowing the patient to stand on the floor.

In one embodiment, the foot board can be slid forward allowing the patient to stand on the floor.

In one embodiment, the front and rear wheels are connected to the chassis by a telescopic rod.

Further, the front end of the chassis is extended horizontally forward with two support rods with wheels at the end of the rod. The rear end of the chassis has a tube that extends backward and has caster wheels at the end.

Embodiments of the present disclosure may include a lift apparatus to facilitate mobility of a user. The lift apparatus may include a chassis having a front wheel attached to a front end of the chassis, a first rod and a second rod extending from a rear end of the chassis, wherein the first rod is spaced apart from the second rod. The lift apparatus may also include a rear wheel attached to a distal end of each of the first rod and the second rod. A column may be provided having a bottom end and a top end, wherein the bottom end is attached to the chassis. Embodiments may also include an arm rest disposed adjacent the top end of the column. A winch may be included that is supported by one of from the group consisting of the chassis and the column. The winch may include a tow rope having a distal end and a hook disposed at the distal end of the tow rope, the winch configured to selectively payout and retract the tow rope. The lift apparatus may also include a harness configured to attach to the user and include a harness pulling loop for selectively coupling to the hook of the tow rope of the winch, the winch facilitating a lifting of the user as the tow rope may be retracted by the winch and facilitating a lowering of the user as the tow rope may be paidout by the winch.

In some embodiments, the arm rest may be one of a rectangular shape and a c-shape.

In some embodiments, the lift apparatus may include a knee board attached to the column and configured to engage the user.

In some embodiments, the lift apparatus may include a guide ring disposed on the arm rest, the guide ring configured to receive the tow rope through the guide ring.

In some embodiments, the winch may be one of a manual winch and an electrical winch.

In some embodiments, the lift apparatus may include an electrical energy source, the electrical energy source in electrical communication with the electrical winch.

In some embodiments, the lift apparatus may also include a control system in electrical communication with the electrical winch and the electrical energy source, the control system configured to selectively control a flow of electrical energy to the electrical winch. The control system may also includes a user interface to facilitate the user selectively controlling the flow of electrical energy to the electrical winch, wherein the user interface may be at least one of a wired user interface and a wireless user interface.

In some embodiments, the front wheel and the rear wheel may be selected from the group consisting of a caster wheel and a disk wheel.

In some embodiments, the lift apparatus may include a drive motor configured to provide rotational motion to the front wheel of the chassis, and an electrical energy source, the electrical energy source in electrical communication with the drive motor.

In some embodiments, the lift apparatus may include a control system including a user interface, the control system in electrical communication with the drive motor and the electrical energy source, the user interface configured to cooperate with the control system to facilitate the user selectively controlling a flow of electrical energy to the drive motor.

In some embodiments, the column includes a first vertical member and a second vertical member, a positioning through hole may be formed in each of the first vertical member and the second vertical member, the second vertical member being slidably received over a portion of the first vertical member and selectively aligning the positioning through hole of the first vertical member with the positioning through hole of the second vertical member, a positioning pin configured to be received by the positioning through hole of the first vertical member and the positioning through hole of the second vertical member to define a selected length of the column.

In some embodiments, the lift apparatus may include a support rod extending outwardly from the front end of the chassis configured to maximize a stability of the chassis.

In some embodiments, the lift apparatus may include a seat disposed on the column configured to be selectively moved from a center area of the chassis to a side area of the chassis.

In some embodiments, the lift apparatus may include a board movably attached to the chassis, the board configured to be selectively positioned between the first rod and the second rod extending from a rear end of the chassis for the user to stand on the board when the board is positioned between the first rod and the second rod. A caster wheel may be provided on a surface of the board, the caster wheel configured to contact a ground surface and support the board when a user stands on the board.

Embodiments of the present disclosure may also include a lift apparatus to facilitate mobility of a user, including a chassis having a front wheel attached to a front end of the chassis, the front wheel being one of a caster wheel and a disk wheel. The chassis may also include a first rod and a second rod extending from a rear end of the chassis, the first rod spaced apart from the second rod, wherein a rear caster wheel is attached to a distal end of each of the first rod and the second rod.

Embodiments may also include a board movably attached to the chassis, the board configured to be selectively positioned between the first rod and the second rod extending from the rear end of the chassis.

The lift apparatus may also include a column having a bottom end and a top end, the bottom end attached to the chassis. In some embodiments, the column includes a first vertical member and a second vertical member. A positioning through hole may be formed in each of the first vertical member and the second vertical member. The second vertical member may be slidably received over a portion of the first vertical member and selectively aligning the positioning through hole of the first vertical member with the positioning through hole of the second vertical member. A positioning pin may be provided that is configured to be received by the positioning through hole of the first vertical member and the positioning through hole of the second vertical member to define a selected length of the column.

Embodiments may also include an arm rest having a “C” shape disposed adjacent the top end of the column.

The lift apparatus may also include an electrical winch supported by one of from the group consisting of the chassis and the column, the electrical winch including a tow rope having a distal end and a hook disposed at the distal end of the tow rope, wherein the electrical winch is configured to selectively payout and retract the tow rope.

Embodiments may also include a guide ring disposed on at least one of the column and the arm rest, wherein the guide ring is configured to receive the tow rope through the guide ring.

Embodiments may also include an electrical energy source, the electrical energy source in electrical communication with the electrical winch. Embodiments may also include a control system in electrical communication with the electrical winch and the electrical energy source. The control system may include a user interface to facilitate the user selectively controlling a flow of electrical energy to the electrical winch, wherein the user interface is at least one of a wired user interface and a wireless user interface.

Embodiments may also include a harness configured to attach to the user and including a harness pulling loop for selectively coupling to the hook of the tow rope of the electrical winch, wherein the electrical winch facilitates a lifting of the user as the tow rope is retracted by the electrical winch and facilitating a lowering of the user as the tow rope is paidout by the electrical winch.

In some embodiments, the lift apparatus may include a drive motor configured to provide rotational motion to the front wheel of the chassis, the drive motor in electrical communication with the user interface, the control system, and the electrical energy source. The user interface may be further configured to facilitate the user selectively controlling a flow of electrical energy to the drive motor.

In some embodiments, the lift apparatus may include a knee board attached to the column and configured to engage the user.

Embodiments of the present disclosure may also include a method of using a lift apparatus by a user, the method including steps of providing a lift apparatus. The lift apparatus may include a chassis having a front wheel attached to a front end of the chassis and a first rod and a second rod extending from a rear end of the chassis, wherein the first rod is spaced apart from the second rod. A rear wheel may be attached to a distal end of each of the first rod and the second rod. Embodiments may also include a column having a bottom end and a top end, the bottom end attached to the chassis and an arm rest disposed adjacent the top end of the column.

The lift apparatus may also include a winch supported by one of from the group consisting of the chassis and the column, the winch including a tow rope having a distal end and a hook disposed at the distal end of the tow rope. The winch may be configured to selectively payout and retract the tow rope.

Embodiments may also include a harness configured to attach to the user. The harness may include a harness pulling loop for selectively coupling the harness to the hook of the tow rope of the winch, wherein the winch facilitates a lifting of the user as the tow rope is retracted by the winch and facilitates a lowering of the user as the tow rope is paidout by the winch. Embodiments may also include performing, by the user of the lift apparatus, one of lifting to a standing position as the tow rope is retracted by the winch, lowering to a sitting position as the tow rope is paidout by the winch, walking while being supported by the lift apparatus, and being transported by the lift apparatus while being supported by the lift apparatus.

The advantage of the present invention is: mobility aid has electric version and manual version, the electric version of which does not require the help of any other person, allows the disabled person to move freely indoors or outdoors in sitting or standing position, it can pull the patient up in to standing position, support the patient in standing position, and carry the patient to move around in standing position or sitting position. While the manual version of the mobility aid can easily pull a patient up from sitting to standing position, maintain the patient in standing and can be easily pushed around. It is labor-saving and trouble-free.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side perspective view of the lift transfer apparatus according to one embodiment of the present disclosure.

FIG. 2 is a front perspective view of the lift transfer apparatus according to another embodiment of the present disclosure.

FIG. 3 is a front perspective view of the lift transfer apparatus according to another embodiment of the present disclosure.

FIG. 4 is a side perspective view of the lift transfer apparatus according to another embodiment of the present disclosure.

FIG. 5 is a side top perspective view of the lift transfer apparatus according to another embodiment of the present disclosure, including a seat in a first position.

FIG. 6 is a side perspective view of the lift transfer apparatus of FIG. 5 showing the seat in a second position.

FIG. 7 is a side top perspective view of the lift transfer apparatus according to another embodiment of the present disclosure.

FIG. 8 is a side elevational view of the lift transfer apparatus according to another embodiment of the present disclosure.

FIG. 9 is a side top perspective view of the lift transfer apparatus according to another embodiment of the present disclosure, including a board in a first position.

FIG. 10 is a side top perspective view of the lift transfer apparatus of FIG. 9 showing the board in a second position.

FIG. 11 is a partial side perspective view of the lift transfer apparatus according to another embodiment of the present disclosure.

FIG. 12 is a rear perspective view of the lift transfer apparatus according to another embodiment of the present disclosure.

FIG. 13 is a front perspective view of the lift transfer apparatus according to another embodiment of the present disclosure.

FIG. 14 is a rear perspective view of the lift transfer apparatus according to another embodiment of the present disclosure.

FIG. 15 is a front elevational view of a harness according to an embodiment of the present disclosure, the harness worn by a user of the lift transfer apparatus of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The following will be a specific embodiment combined with the accompanying drawings to illustrate the structure of the present invention and the desired technical effect, but the selected embodiments are for illustrative interpretation only and are not intended to limit the scope of the present invention.

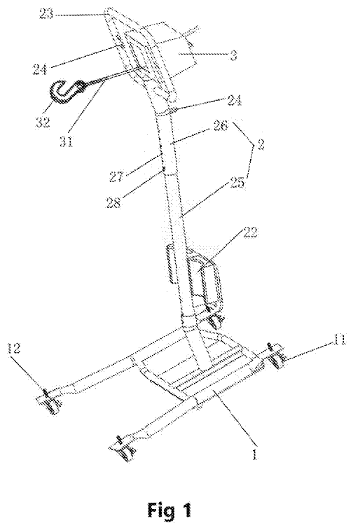

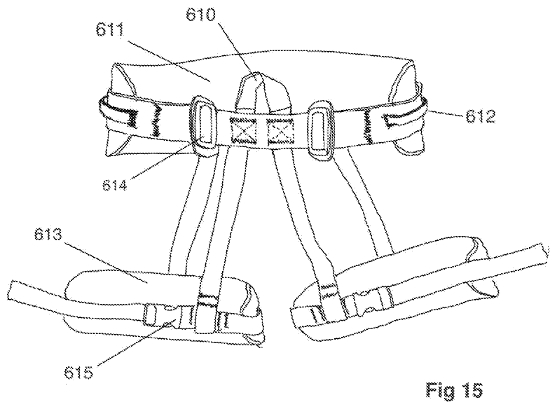

As shown in FIG. 1, the present invention provides an assistive device for disabled persons in mobility, it comprising chassis 1. The front and rear end of chassis 1 are provided with front wheels 11 and rear wheels 12, a pole 2 that extends up in the middle of the front of the chassis. At the bottom of the pole 2 is a board 22 that has two cushions corresponding to the human shine, and each cushion cross-section is C-shaped, and the opening is facing the chassis back end, and there is a sponge pad for comfort. The cushion can be adjusted up, down, forward and backward to fit the height of the disabled, and the board 22 supports the patient's standing position by blocking both knees from buckling. The top of the pole 2 is provided with armrest 23, a winch 3 mounted on the top of pole 2, a tow rope 31 of the winch 3 of through the armrest 23, and the end is provided with a safety hook 32, connected to the wearable harness pulling loop 610 show in FIG. 15. In the present embodiment, the winch 3 is a manual winch, located at the top of the pole 2. The front wheel 11 and rear wheel 12 are both caster wheels.

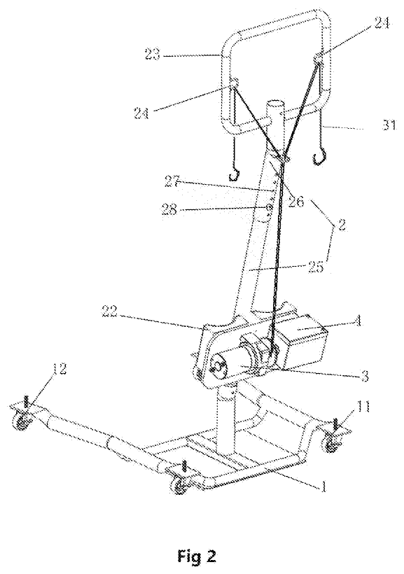

For the convenience of the patient, the armrest 23 of the present invention design is located at the top of the pole 2, and the user can pull themselves up to the arm rail 23 if they have an adequate upper limb strength. It is convenient for the disabled to pull themselves up from the sitting position by grasping the armrest with their own strength. This armrest 23 extends upwards on the left and right sides of the pole 2, thus increasing its grip range, and the armrest 23 simultaneously plays a role in stabilizing the trunk of the patient. In this way, this armrest 23 not only facilitates its transition from sitting and standing, but also makes the user stable to stand and drive. As shown in FIG. 2, which is an embodiment of the present invention, the difference with Example 1 is that the winch 3 is an electric winch, disposed on the back of the board 22. Of course, it can also be placed at the top of this column 2 or on top of the chassis. The board 22 is provided with a battery 4 on the back, connected to the electric winch. Of course, battery 4 may also be located on chassis 1. Since the patient with leg weakness needs continuous support while standing, the best option is to use the electric winch to maintain constant pulling while standing. The electric winch has a self-locking mechanism that allows the patient to relax while standing, and the winch is controlled by the patient. In the present invention, the winch 3 can be loaded and unloaded at any time, and the electric winch can be replaced by a manual winch at any time to reduce its cost and weight. Since the towing rope 31 of the winch 3 can change its length at any time, the user of the present invention doesn't have to disconnect the tow rope 31 throughout the day. They may stand up or sit down, can sit in a regular chair, toilet, bed, stand, or drive while standing,

The connection between the pole 2 and the chassis 1 of the present invention is not only firm but also can be removed at any time, thereby reducing the shipping package size. Winch 3 may be fixed to the top of the pole 2, and can also be fixed to the back of the board 22. When the winch 3 is fixed to the back of the board 22, its towing rope 31 goes through the guide ring 24 to connect with the patient. Guide ring 24 is mounted on both sides of the handrail of armrest 23, and the towing rope 31 is split into two ropes, each passing through the corresponding ring 24. By using sided guide ring 24, it changes the central pulling to bilateral simultaneous pulling, which increases the stability. Since both sides are pulled up and held in place, the both sides of the user are supported. This provides greater bilateral stability for driving in standing position.

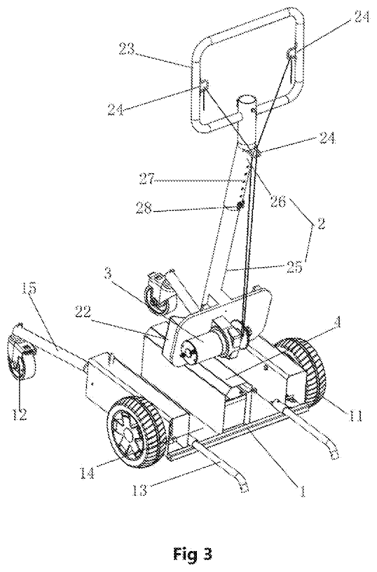

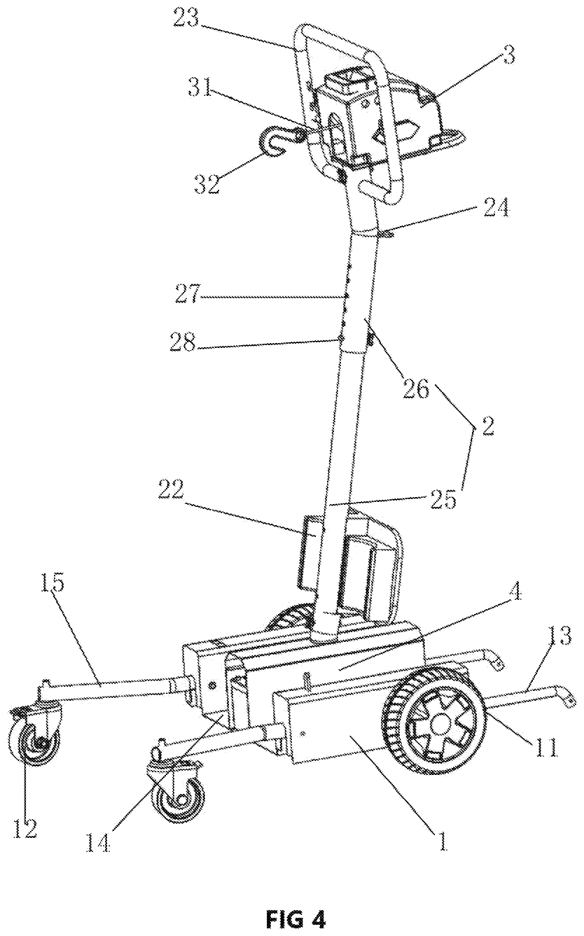

As shown in FIG. 3 and FIG. 4, which is another embodiment of the present invention, the difference with Example 2 is that the front wheel 11 is connected to the driving motor (not shown in FIG), the driving motor is connected to the battery 4. In the present embodiment, the battery 4 is located on chassis 1. The patient wears a harness and steps onto chassis 1. Their shins are pushed on board 22, and the tow rope 31 is fixed to the left and right sides of the harness by the safety hook 32. The disabled person can change from a sitting position to a standing position by controlling the winch 3 that pulls them up. The winch 3 has an electric locking function and continues holding the patient up after pulling them up. The patient can operate the drive motor on chassis 1 to move around in a supported standing position.

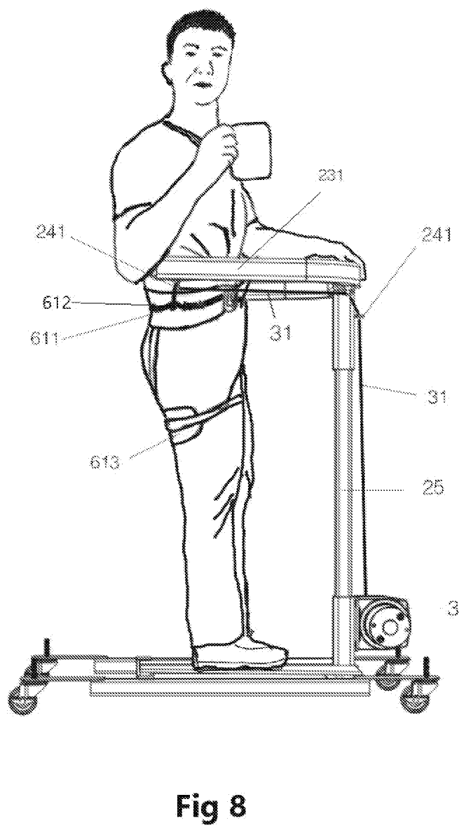

In addition, to make it safer and more stable, this mobility aid device can also have a lifting arm 231 extended backward to the both side of patient (shown in the FIGS. 8 to 14) corresponding to the patient's waist when the patient stands up. Rope guiding ring 241 mounted under the lift arm 231. This way changes to towing rope direction, therefore resulting in a stronger pulling force in an upward direction, reducing the possibility of tipping and falling during the transfer from sitting position to standing position. At this time the knee board is not needed. Further, chassis 1 is installed with a stabilizer 13, which may extend outward or retract from the chassis. The stabilizer extends forward to prevent the mobility aid from tipping forward. If this stabilizer is not needed, it can be retracted to reduce its size and make driving more convenient. In the present embodiment, the structure of the stabilizing device is: the chassis 1 front end extends horizontally forward with two support rods 13 to prevent forward tipping. Further, this chassis also has two non-slip standing support surfaces 14. These two standing support surfaces 14 are located on both sides of pole 2. In between front wheel 11 and rear wheel 12. This support surface 14 should not be too high off the ground to facilitate the use of the disabled. Further, seat belts can be set up to hold the patient and the pole 2 together. Meanwhile, the continuous pulling on the harness from the tow ropes 31 also stabilizes the patient while driving in standing position.

As show in FIG. 15, The harness of the present invention comprises 2 parts. The upper part 611 is supporting patient waist, while the lower part 613 is supporting patient thigh. so that the pulling force can be distributed more evenly, and the waist is also equipped with pulling loop 610 on front. The multiple hand grips 612 are distributed on both sides and the back side. These hand grips 612 can be connected with tow ropes of the winch 3. The multi-point connectivity includes middle, bilateral pulling, holding the harness in place to improve the stability of patients in use. The design of this harness does not affect the patient's toileting, using quick-drying materials so that the patient can wear it in the shower. Further, the disabled person can continue to wear this harness like one of their clothes, whether sitting, standing, lying down or sleeping. The harness becomes a part of their underwear, and the harness is surrounded by handle grips, which makes it more convenient for others to help the disabled person.

Further, the drive motor and winch 3 are connected to the control system, which is equipped with a wire control and remote-control dual control device. This is convenient for the user to remotely control the assist device from a distance or operate by themselves.

We tend to switch freely between wired and wireless driving. While the patient is driving using the wire, they tend to use a joystick device so that the user only needs to flick the joystick with their finger to drive. Remote driving devices tend to use mobile phones or tablet touch screen devices. Thus, the winch 3 of the present invention may be remotely controlled or wire controlled. When the patient uses a remote-control driving function, the user carries a remote control device such as a smartphone or tablet so that the assist device can be parked at a certain distance from the user. When the patient needs to use it, they can remotely control the assist device to them. They can control the winch by themselves through the controller 3. By changing the length of the tow rope 31, they can change from standing to sitting position or vice versa. This allows them to freely switch from wheelchairs to bed and toilets or switch their positions from sitting to standing. Since disabled persons can maintain a standing position and move freely, they can do what they need to do in daily life, such as laundry, cooking, sorting cabinets and so on.

Chassis 1 of the present invention is installed with at least one drive motor. Where a drive motor on each side is preferred, the motors of the left and right sides are connected with their own drive wheels (front wheel 11). The drive wheels are symmetrically distributed on both sides of the chassis 1. This allows the speed of the mobility aid to be adjusted by controlling the speed and direction of the drive motor. The patient can control it to move forward, backwards or turn side to side. In addition to these two drive wheels, this chassis has two back wheels (rear wheel 12), and here two caster wheels are preferred, which facilitates the direction change. Chassis 1 also has a power supply, charging device, and battery to support the driving motor and electric winch.

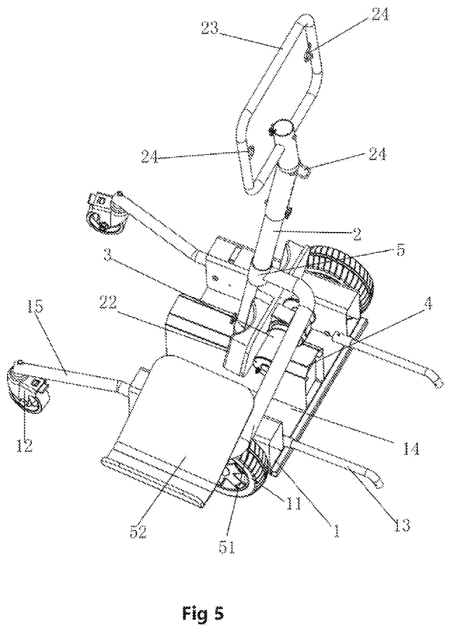

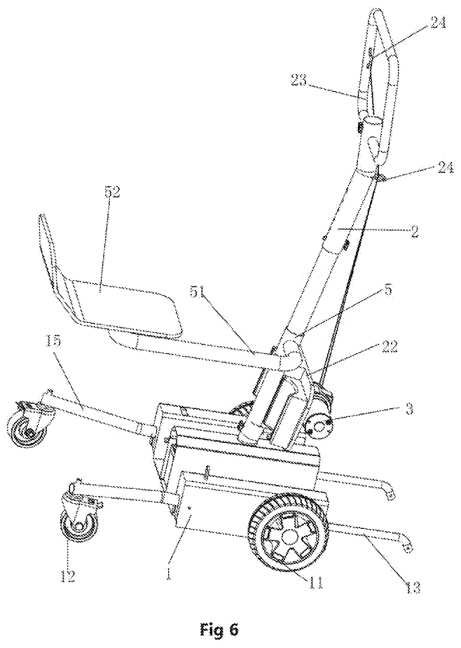

In the above embodiment, as shown in FIG. 5 and FIG. 6, pole 2 may also have an external tube 5. This external tube 5 can rotate round pole 2. At one side of the external tube 5 has rod 51 extended out and seat 52 mounted at the end of the rod 51. Before use, the seat support rod 51 rotates to the side. When using, the user first uses the winch 3 to assist pulling upward to stand on the walking aid device. The patient can maintain upright position by continuing to pull the tow rope 31, and then rotate the seat support rod 51 and make the seat 52 positioning under the user's buttock and locking in place. Then, the user can sit on seat 52 to rest or drive the mobility aid around in a sitting position.

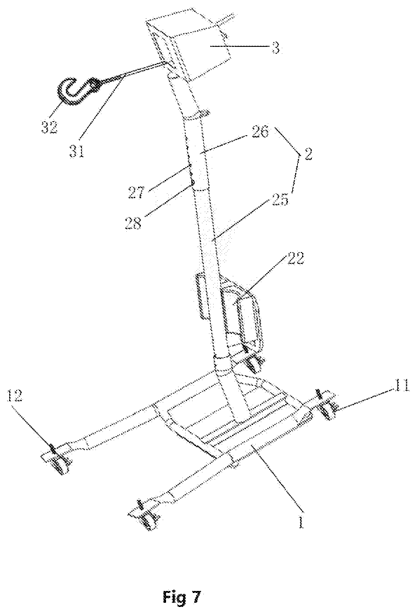

As shown in FIG. 7 which is an embodiment of the present invention 6, which is the simplest form, the difference with Example 1 is that there is no rectangular handrail provided.

As shown in FIGS. 8 to 14, is another embodiment, The left and right end of the armrest 23 extended backward as part of lifting arm 231, the arms constructed as a letter “c” that is opened towards the user, while it can support the trunk on each side along with both elbows. It also has guiding rings 241 mounted at the bottom of armrest 231. The towing rope 31 is split into two ropes that each pass through the corresponding ring 241 on each side. By using “C” shaped armrest 231 and guiding rings 241, changes the forward pulling to bilateral upward pulling and holds the patient up on both sides. It also reduces the possibility of tipping and falling during transfer from sitting to standing. At this time, the knee board is optional.

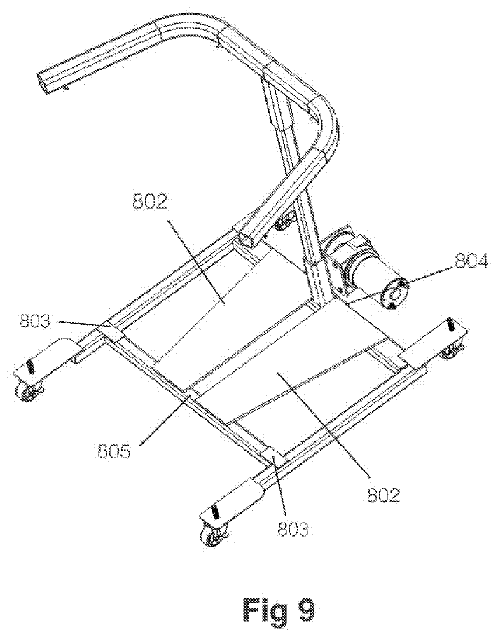

As shown in FIG. 9 the supporting surface constructed as two board 802 mirrored on both side of the pole 25, front of the two board 802 connected by plate 804 and back of the board mounted on tube 805. Two place 803 mounted on both end of the tube 805 and rested on main frame on each side.

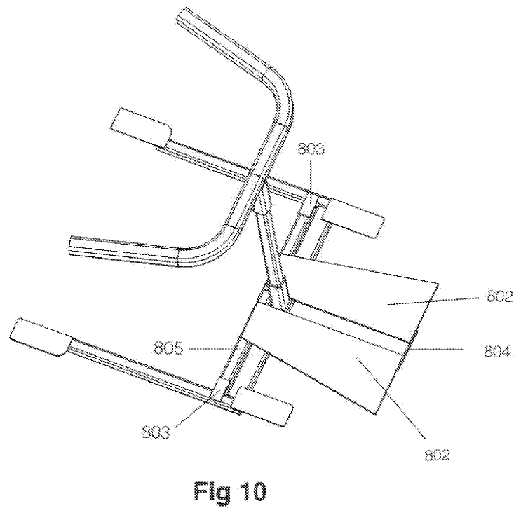

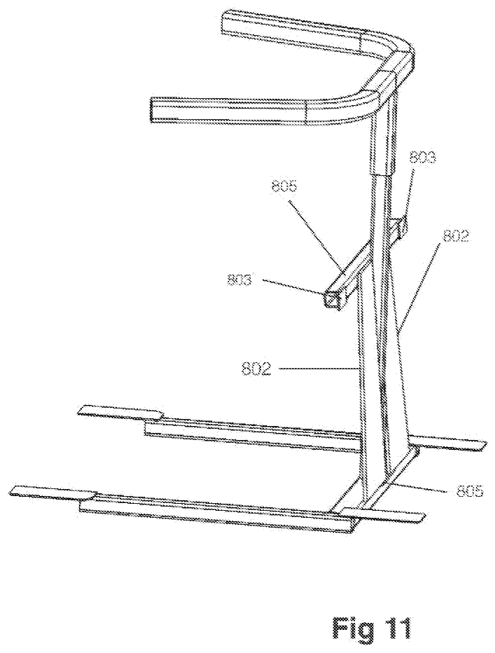

As shown in FIG. 10 and FIG. 11, the supporting surface can be slide forward or flip up. that allow patient stand on floor. Due to their harness is pulled up on both side and their arms are rested on lift arm, so their body is supported and patient can practice walking safely with very minimal legs strength.

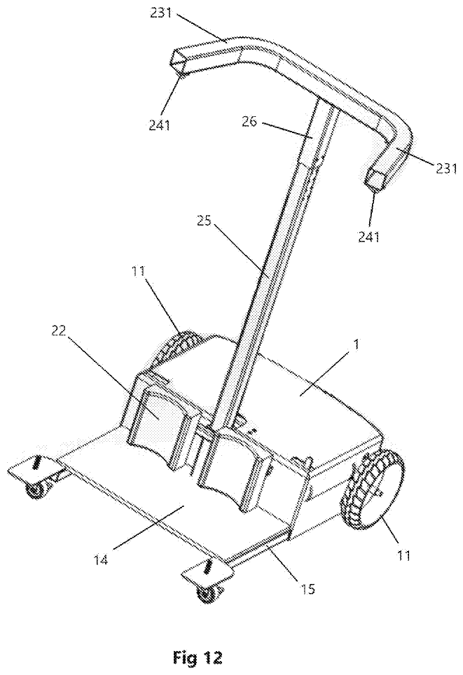

As shown in FIG. 12, the electric winch is mounted on chases 1, tow rope 31 guided by guiding ring 241 to both side of the patient. with driving motor on each side, the patient can drive around with their body weight lifted and trunk supported on both sides.

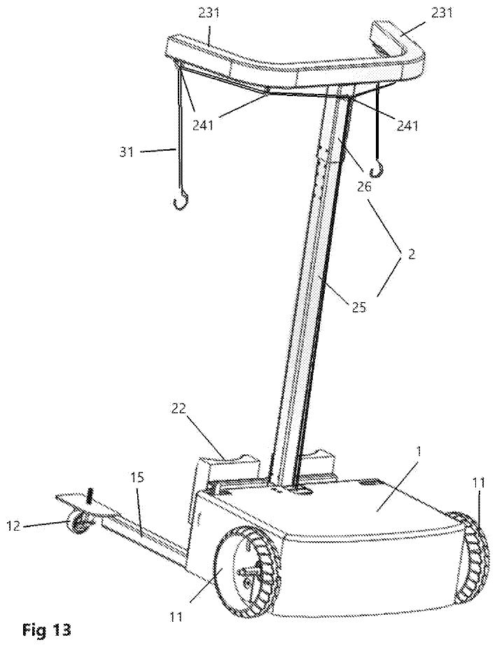

As shown in FIG. 13, the support board 14 can be removed, this way leaving the open space so that the patient can stand on ground while using it to practice walking. At this time, the pulling rope 31 of the winch 3 pulled the harness to support patient body weight and both elbows supported on lift arm 231.

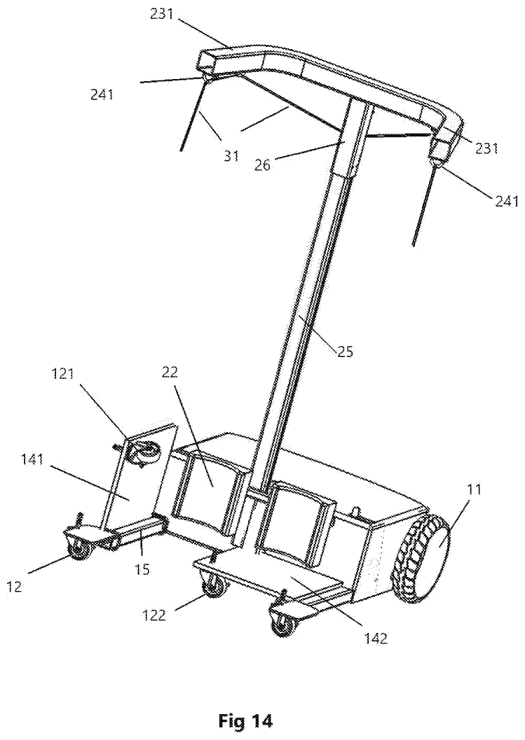

As shown in FIG. 14, The standing surface can also be lifted up to the side and put down as needed. In this case, the support 14 is divided to 141 and 142 on each side, has hinges on the lateral side 145 and 146, has caster wheels 121 and 122 at bottom of the board to support it on ground, and has plate 149 in front of chasse to hold board 141 and 142 in place while put down.

In addition, the chassis has foot boards 141 and 142 that can be flipped up laterally as double doors to open or close on the bottom of the chassis. The opening is big enough for a patient to move their legs and make normal steps. There are caster wheels 121 and 122 on each board to support the board on the floor when it is placed down for the patient to stand on it. The patient will be able to stand on the floor with one foot or both feet when one or both foot boards are flipped up. The tow rope 31 pulls up on both sides of the harness to take the patient's body weight, and they can move their legs to practice walking with their body weight supported.

To achieve the goal of pulling a person from the sitting position to standing, the towing rope 31 of the winch 3 is required to have a certain height, higher than the waist of the user when standing. The height of the tow rope 31 of the winch 3 can be adjusted at any time because the height of the user is very different, such as 1.5 meters tall or 2 meters tall. Patients need to use the same type of shifter, especially quadriplegic patients who need to use a full body harness to support their body. The pulling point needs to be above the chest, which requires that the height of the winch 3 of the or towing rope 31 can be adjusted according to the actual height of the user. Thus, in the present invention, pole 2 is a telescope tubing structure that can be stretched or extended. Before use, the patient needs to adjust the height of the towing rope 31 (i.e., the handrail 23) of its winch 3 about 3 to 4 inches above the navel. For patients with quadriplegia, the height of winch 3 is adjusted to 3 to 4 inches above their chest. In the above embodiment, pole 2 includes a first vertical pipe 25 and a second vertical pipe 26. The bottom of second vertical pipe 26 is sleeved over the upper part of the first vertical pipe 25, and there are several corresponding positioning holes 27 between the two pipes. The corresponding positioning holes of the first vertical pipe and the second vertical pipe are provided with a positioning pin 28. This not only facilitates the adjustment of the height, but also reduces the side during transport or shipping. The tube can also be disassembled so that it can be put into the trunk of the car. In the above embodiment, the front wheel 11 and the rear wheel 12 is connected between the rear wheel and the chassis via a telescopic rod 15 to fold the front wheel 11 and rear wheel 12 into the chassis 1 for easy transport.

The method of use of the present invention: when the patient gets up from bed, they first sit on the edge of their bed, then put the harness on or have the harness in place before getting up. After that, the patient can remotely start up the assistive aid through the remote control device or app on the smartphone or tablet, and drive the device to him through the remote control driving app. The patient places their feet on the foot board 14 on the chassis 1, and their shins are placed against the kneeboard 22 of the device. Through wire control or remote control, the patient releases the tow rope 31 of the winch 3 and fastens the safety hook 32 to the left and right sides of the waist guard handle of the harness. The patient shortens the tow rope 31 to pull themselves into standing position. When the patient is pulled to the fully standing position, the winch 3 automatically stops and locks through the electronic locking mechanism. At this point, the patient is firmly fixed in the standing position. The patient can drive the device through a joystick or through a drive app. When the patient decides to use the toilet, they drive the device to the front of the toilet, backwards to the appropriate position, and lock the driving motor by activating the electronic brake. The patient relaxes the tow rope 31 until they sit firmly on the toilet. By controlling the winch 3, the sitting and standing position of the disabled person can be changed, and the disabled person can stand on the assistive aid and move around.

When a patient wants to practice walking, they should remove the footboard 14 or flip foot board 141 and 142 up on each side before standing up. They should then place their feet on the floor and scoot forward so their shins are against the kneeboard 22 of the device. Through wire control or remote control, the patient should release the tow rope 31 of the winch 3 and fasten the safety hook 32 to the left and right sides of the waist guard handle of the harness. The patient should use the controller to control winch 3 to shorten the tow rope 31 to pull themselves into standing position. After the patient is pulled to the fully standing position, the winch 3 automatically stops and locks through the electronic locking mechanism. At this point, the patient is firmly fixed in the standing position. The patient can drive the device through a joystick or through the app. When the device moves forward, the patient can follow by moving their feet forward and make steps with their body weight supported.

By the functionality of the present invention, the electric winch can pull the disabled person from a sitting position to a standing position and maintain their feet on foot support 14 of the chassis 1. At the same time, the electric winch continues to support the disabled person who is driving in standing position by pulling upward on harness through tow rope 31. People with disabilities can use this device to transfer from sitting to standing without any assistance from others. If the drive motor of the chassis is removed, the disabled person can be moved in standing position by being dragged by another person. If the electric winch is replaced by the manual winch, people with disabilities can also change their sitting and standing positions with the help of others.

Because the patient can stand and drive without any obstruction above their chest when standing, their upper body and arms can move freely, which greatly enhances the functional range of both arms and makes their daily life very convenient. At different times of the day, the disabled person will switch between sitting, standing and driving freely because the disabled person can control the winch by himself, so these changes are very convenient.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A lift apparatus to facilitate mobility of a user, comprising:
a chassis including
a front wheel attached to a front end of the chassis,
a first rod and a second rod extending from a rear end of the chassis, the first rod spaced apart from the second rod,
a rear wheel attached to a distal end of each of the first rod and the second rod;
a column having a bottom end and a top end, the bottom end attached to the chassis;
an arm rest disposed adjacent the top end of the column;
a winch supported by one of from the group consisting of the chassis and the column, the winch including a tow rope having a distal end and a hook disposed at the distal end of the tow rope, the winch configured to selectively payout and retract the tow rope; and
a harness configured to attach to the user and including a harness pulling loop for selectively coupling to the hook of the tow rope of the winch, the winch facilitating a lifting of the user as the tow rope is retracted by the winch and facilitating a lowering of the user as the tow rope is paidout by the winch.

2. The lift apparatus of claim 1, wherein the arm rest is one of a rectangular shape and a c-shape.

3. The lift apparatus of claim 1, including a knee board attached to the column and configured to engage the user.

4. The lift apparatus of claim 1, including a guide ring disposed on the arm rest, the guide ring configured to receive the tow rope through the guide ring.

5. The lift apparatus of claim 1, wherein the winch is one of a manual winch and an electrical winch.

6. The lift apparatus of claim 5, including an electrical energy source, the electrical energy source in electrical communication with the electrical winch.

7. The lift apparatus of claim 6, further comprising a control system in electrical communication with the electrical winch and the electrical energy source, the control system configured to selectively control a flow of electrical energy to the electrical winch.

8. The lift apparatus of claim 7, wherein the control system includes a user interface to facilitate the user selectively controlling the flow of electrical energy to the electrical winch, the user interface being at least one of a wired user interface and a wireless user interface.

9. The lift apparatus of claim 1, wherein the front wheel and the rear wheel are selected from the group consisting of a caster wheel and a disk wheel.

10. The lift apparatus of claim 1, including a drive motor configured to provide rotational motion to the front wheel of the chassis, and an electrical energy source, the electrical energy source in electrical communication with the drive motor.

11. The lift apparatus of claim 10, further comprising a control system including a user interface, the control system in electrical communication with the drive motor and the electrical energy source, the user interface configured to cooperate with the control system to facilitate the user selectively controlling a flow of electrical energy to the drive motor.

12. The lift apparatus of claim 1, wherein the column includes a first vertical member and a second vertical member, a positioning through hole is formed in each of the first vertical member and the second vertical member, the second vertical member being slidably received over a portion of the first vertical member and selectively aligning the positioning through hole of the first vertical member with the positioning through hole of the second vertical member, a positioning pin configured to be received by the positioning through hole of the first vertical member and the positioning through hole of the second vertical member to define a selected length of the column.

13. The lift apparatus of claim 1, including a support rod extending outwardly from the front end of the chassis configured to maximize a stability of the chassis.

14. The lift apparatus of claim 1, including a seat disposed on the column configured to be selectively moved from a center area of the chassis to a side area of the chassis.

15. The lift apparatus of claim 1, including a board movably attached to the chassis, the board configured to be selectively positioned between the first rod and the second rod extending from a rear end of the chassis for the user to stand on the board when the board is positioned between the first rod and the second rod.

16. The lift apparatus of claim 15, wherein a caster wheel is disposed on a surface of the board, the caster wheel configured to contact a ground surface and support the board when a user stands on the board.

17. A lift apparatus to facilitate mobility of a user, comprising:
a chassis including
a front wheel attached to a front end of the chassis, the front wheel being one of a caster wheel and a disk wheel,
a first rod and a second rod extending from a rear end of the chassis, the first rod spaced apart from the second rod,
a rear caster wheel attached to a distal end of each of the first rod and the second rod,
a board movably attached to the chassis, the board configured to be selectively positioned between the first rod and the second rod extending from the rear end of the chassis;
a column having a bottom end and a top end, the bottom end attached to the chassis,
the column includes a first vertical member and a second vertical member, a positioning through hole is formed in each of the first vertical member and the second vertical member, the second vertical member being slidably received over a portion of the first vertical member and selectively aligning the positioning through hole of the first vertical member with the positioning through hole of the second vertical member, a positioning pin configured to be received by the positioning through hole of the first vertical member and the positioning through hole of the second vertical member to define a selected length of the column;
an arm rest having a “C” shape disposed adjacent the top end of the column;
an electrical winch supported by one of from the group consisting of the chassis and the column, the electrical winch including a tow rope having a distal end and a hook disposed at the distal end of the tow rope, the electrical winch configured to selectively payout and retract the tow rope;
a guide ring disposed on at least one of the column and the arm rest, the guide ring configured to receive the tow rope through the guide ring;
an electrical energy source, the electrical energy source in electrical communication with the electrical winch;
a control system in electrical communication with the electrical winch and the electrical energy source, the control system including a user interface to facilitate the user selectively controlling a flow of electrical energy to the electrical winch, the user interface being at least one of a wired user interface and a wireless user interface; and
a harness configured to attach to the user and including a harness pulling loop for selectively coupling to the hook of the tow rope of the electrical winch, the electrical winch facilitating a lifting of the user as the tow rope is retracted by the electrical winch and facilitating a lowering of the user as the tow rope is paidout by the electrical winch.

18. The lift apparatus of claim 17, further comprising a drive motor configured to provide rotational motion to the front wheel of the chassis, the drive motor in electrical communication with the user interface, the control system, and the electrical energy source, the user interface further configured to facilitate the user selectively controlling a flow of electrical energy to the drive motor.

19. The lift apparatus of claim 17, further comprising a knee board attached to the column and configured to engage the user.

20. A method of using a lift apparatus by a user, the method comprising the steps of:
providing a lift apparatus including
a chassis having
a front wheel attached to a front end of the chassis,
a first rod and a second rod extending from a rear end of the chassis, the first rod spaced apart from the second rod,
a rear wheel attached to a distal end of each of the first rod and the second rod,
a column having a bottom end and a top end, the bottom end attached to the chassis,
an arm rest disposed adjacent the top end of the column,
a winch supported by one of from the group consisting of the chassis and the column, the winch including a tow rope having a distal end and a hook disposed at the distal end of the tow rope, the winch configured to selectively payout and retract the tow rope, and
a harness configured to attach to the user, the harness including a harness pulling loop for selectively coupling the harness to the hook of the tow rope of the winch, the winch facilitating a lifting of the user as the tow rope is retracted by the winch and facilitating a lowering of the user as the tow rope is paidout by the winch;
performing, by the user of the lift apparatus, one of:
lifting to a standing position as the tow rope is retracted by the winch;
lowering to a sitting position as the tow rope is paidout by the winch;
walking while being supported by the lift apparatus; and
being transported by the lift apparatus while being supported by the lift apparatus.
